(19) United States
(12) Patent Application Publication
(10) Pub. No.: US 2016/0140780 A1
(43) Pub. Date: May 19, 2016

(54) SYSTEM AND METHOD OF CALCULATING DISTANCE TO EMPTY OF ECO-FRIENDLY VEHICLE

(71) Applicant: Hyundai Motor Company, Seoul (KR)

(72) Inventor: Sang Joon Kim, Gangseo-gu (KR)

(21) Appl. No.: 14/868,517

(22) Filed: Sep. 29, 2015

(30) Foreign Application Priority Data
Nov. 18, 2014 (KR) 10-2014-0160854

(51) Int. Cl. G07C 5/02; B60R 16/023

(52) U.S. Cl. CPC G07C 5/02; B60R 16/0236

(57) ABSTRACT

A calculation method and system of the distance to empty of the eco-friendly vehicle are provided. The method permits the distance to empty to be more accurately calculated, by deriving a governing equation for converting the energy consumption of the air conditioner into fuel consumption, and by more accurately converting the fuel consumption reduction (contribution) of the air conditioner through the suitable selection of factors of this equation.

### CROSS-REFERENCE TO RELATED APPLICATION

This application claims under 35 U.S.C. §119(a) the benefit of Korean Patent Application No. 10-2014-0160854 filed on Nov. 18, 2014, the entire contents of which are incorporated herein by reference.

### BACKGROUND

(a) Technical Field

The present disclosure relates to a system and method of calculating a distance to empty of an eco-friendly vehicle. More particularly, to a system and method of calculating a distance to empty of an eco-friendly vehicle which allows the distance to empty to be more accurately predicted by reflecting the energy consumption based on the operation of an air conditioner.

(b) Background Art

Eco-friendly vehicles, such as electric cars and hybrid vehicles, provide a function of estimating a distance to empty (e.g., a remaining distance to empty) from an energy state of a current battery and displaying the distance on a cluster or the like, in a manner similar to a way of predicting a distance to empty (DTE) from a current gasoline fuel level in an internal combustion engine vehicle and reporting such a level to a driver, in conjunction with the distance to empty based on the battery remaining capacity.

A calculation method of the distance to empty of the electric car as taught by the prior art, includes using a relation between a state of charge (SOC) (%) as the remaining energy of a high-voltage battery and an energy consumption rate per distance of a vehicle. In other words, the distance to empty (km) is calculated as a value obtained by multiplying a learning traveling fuel consumption (km/kWh), which is obtained by combining a past traveling average electricity expense with a current traveling electricity expense, by a battery available energy (kWh).

Meanwhile, when calculating the distance to empty of the electric car, in view of the greater degree of influence on the air-conditioning energy, the distance is calculated using Formula 1 below based on the fuel consumption during operation of the air conditioner.

distance to empty (km)=(learning traveling fuel consumption (km/kWh)×reduced fuel consumption during operation of air conditioner (km/kWh))×battery available energy (kWh) Formula 1):

Accordingly, the fuel consumption is calculated to a level in which the distance to empty is reduced when turning the air conditioner on, by reducing a particular level of fuel consumption in accordance with turning on/off of the air conditioner. However, since there is a difficulty in accurately deriving the energy consumption to the reduced fuel consumption during operation of the air conditioner, there is a demand for a method of more accurately calculating the distance to empty during operation of the air conditioner by more accurately deriving the distance to empty (km/kWh) to more accurately calculate the distance to empty.

The above information disclosed in this section is merely for enhancement of understanding of the background of the invention and therefore it may contain information that does not form the prior art that is already known in this country to a person of ordinary skill in the art.

### SUMMARY

The present invention provides a calculation method and system of a distance to empty of an eco-friendly vehicle which permits the distance to empty to be more accurately calculated, by deriving a governing equation for converting the energy consumption of the air conditioner into fuel consumption, and by more accurately converting the fuel consumption reduction (e.g., degree of contribution) due to the air conditioner by the suitable selection of factors of this equation.

In one exemplary embodiment, the present invention provides a calculation method of a distance to empty method of an eco-friendly vehicle that includes: calculating a reduced fuel consumption during operation of an air conditioner, by the use of a traveling fuel consumption obtained by calculating a traveling fuel consumption, an average vehicle speed obtained by calculating an average vehicle speed, and an air-conditioning power obtained by calculating an air-conditioning power; and calculating a distance to empty using the calculated the reduced fuel consumption during operation of air conditioner.

Through the above-mentioned configuration, the present invention provides the following effects.

According to the present invention, it may possible to more accurately calculate the reduced fuel consumption (km/kWh) during operation of the air conditioner, by calculating a traveling fuel consumption, an average vehicle speed and an air-conditioning power, and ultimately, it may be possible to more accurately calculate and provide the distance to empty based on the operation of the air conditioner.

### BRIEF DESCRIPTION OF THE DRAWINGS

The above and other features of the present invention will now be described in detail with reference to exemplary embodiments thereof illustrated the accompanying drawings which are given hereinbelow by way of illustration only, and thus are not limitative of the present invention, and wherein:

FIG. 1 is a diagram of a hardware configuration for a calculation method of a distance to empty of the eco-friendly vehicle according to an exemplary embodiment of the present invention;

FIG. 2 is a flowchart illustrating a traveling fuel consumption computation of the calculation method of the distance to empty of the eco-friendly vehicle according to an exemplary embodiment of the present invention;

FIG. 3 is a flowchart illustrating an average vehicle speed computation of the calculation method of the distance to empty of the eco-friendly vehicle according to an exemplary embodiment of the present invention;

FIG. 4 is a flowchart illustrating an air-conditioning power computation of the calculation method of the distance to empty of the eco-friendly vehicle according to an exemplary embodiment of the present invention; and

FIG. 5A and 5B are conceptual views of an air-conditioning power computation of a calculation method of the distance to empty of the eco-friendly vehicle according to an exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment. In the figures, reference numbers refer to the same or equivalent parts of the present invention throughout the several figures of the drawing.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Hereinafter reference will now be made in detail to various exemplary embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

Hereinafter, exemplary embodiments of the present invention will be described in detail with reference to the attached drawings.

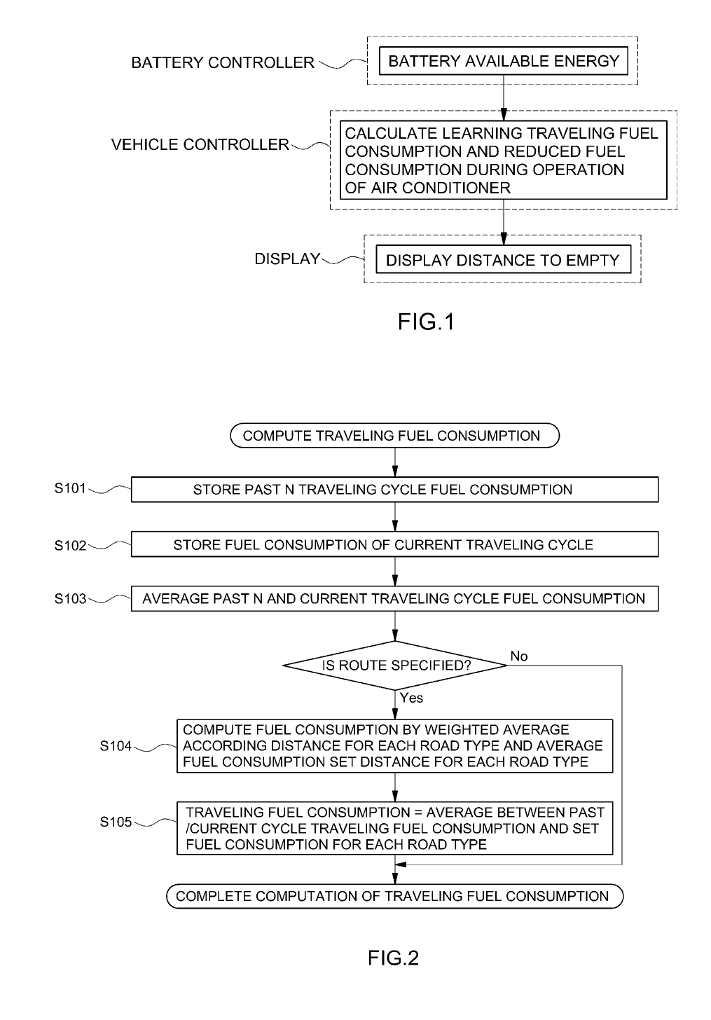

As illustrated in accompanying FIG. 1, hardware main constituents for calculating the distance to empty of the eco-friendly vehicle according to the present invention may include a battery controller configured to calculate the battery available energy based on the detected battery state, a vehicle controller configured to calculate the distance to empty by computing a learning traveling fuel consumption and by simultaneously computing the reduced fuel consumption during operation of the air conditioner, and a cluster and a multi-media display configured to display the calculated distance to empty. The cluster and the multi-media display may be executed by the vehicle controller. The vehicle controller may also be configured to execute the method as described herein below.

The fuel consumption contribution to the operation of the air conditioner computed by the vehicle controller, that is, the reduced fuel consumption during operation of the air conditioner may be calculated by the governing equation such as Equation 2 below.

reduced fuel consumption during operation of the air conditioner (km/kWh)=traveling fuel consumption (km/kWh)−[average vehicle speed (km/h)/[[\textcircled{b} average vehicle speed (km/h)/traveling fuel consumption (km/kWh)]+air-conditioning power (kW)] Equation 2:

In the above Equation 2, the air-conditioning power is changed in units of fuel consumption which is reduced during operation of the air conditioner, and it is important to accurately compute and select traveling fuel consumption, average vehicle speed, and air-conditioning power to be substituted for the above Equation 2.

In particular, the method of computing the traveling fuel consumption, average vehicle speed, and air-conditioning power will be described as follows.

Traveling Fuel Consumption Computation

Accompanying FIG. 2 is a flowchart illustrating the calculating of the traveling fuel consumption. As the traveling fuel consumption, the learning traveling fuel consumption used when computing the distance to empty is used.

The learning traveling fuel consumption may be computed by accumulating a weighted average of the values, which store the values of past N traveling cycles, and a value of the currently traveling data. More specifically, the learning traveling fuel consumption may be computed by storing the past N traveling cycle fuel consumption (S101), storing the fuel consumption of the current traveling cycle (S102), and calculating an average value between the past N traveling cycle fuel consumption and the current traveling cycle fuel consumption (S103).

Meanwhile, when a traveling route is specified by navigation or the like, it may be possible to replace the learning traveling fuel consumption with the computed value by receiving the road information from the navigation system. For example, when the traveling route is specified using a navigation, the fuel consumption may be calculated based on the distance for each road type, an average fuel consumption may be calculated for each road type, a weighted average may be calculated based on the traveling distance (S104), and as a result, the learning traveling fuel consumption may be computed by an average value between the fuel consumption average value computed in the step S103 and the fuel consumption based on the road information computed in the step S104 (S105).

Average Vehicle Speed Computation

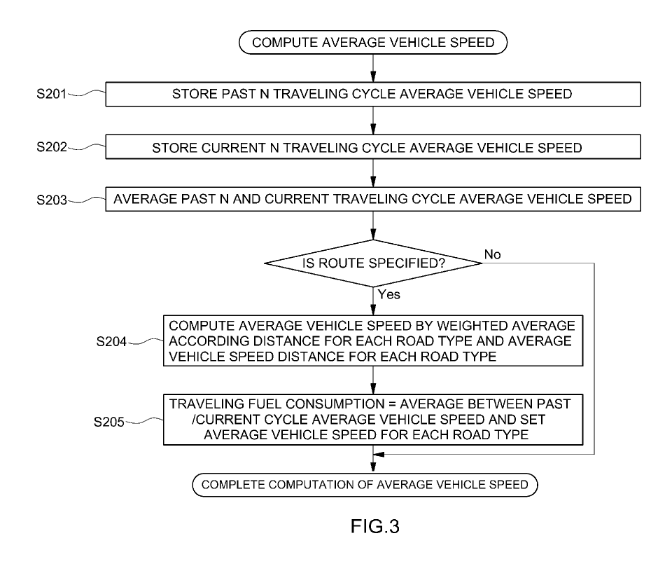

Accompanying FIG. 3 is a flowchart illustrating the calculation of the average vehicle speed. The average vehicle speed may be calculated using the weighted average between the past data used when computing the traveling fuel consumption and data of the current traveling cycle.

First, the average vehicle speed of the past N traveling cycles may be stored (S201). For example, when computing the past traveling cycle using the N buffers serving as a temporary storage device included in the controller, time between each charging of the battery may be defined as one traveling cycle, and the average vehicle speed for each traveling cycle may be computed and stored in the N buffer. The average vehicle speed from the beginning to the current of the current traveling cycle may also be computed and stored (S202).

Further, an average value between the average vehicle speed of the past traveling cycle and the average vehicle speed of the current traveling cycle stored in the N buffers may be calculated (S203). When the traveling route is determined by the navigation, the distance for each road type and the average speed for each road type may be received from the navigation system and the average vehicle speed of averaging them may be computed by the controller (S204). In particular, the road type varying based on the country/navigation, and the distance and the average vehicle speed based on the defined road type may be used. Therefore, the average vehicle speed may be computed using an average value between the average value taken in the process S203 and the average vehicle speed computed in the process S204 (S105).

Air-conditioning Power Computation

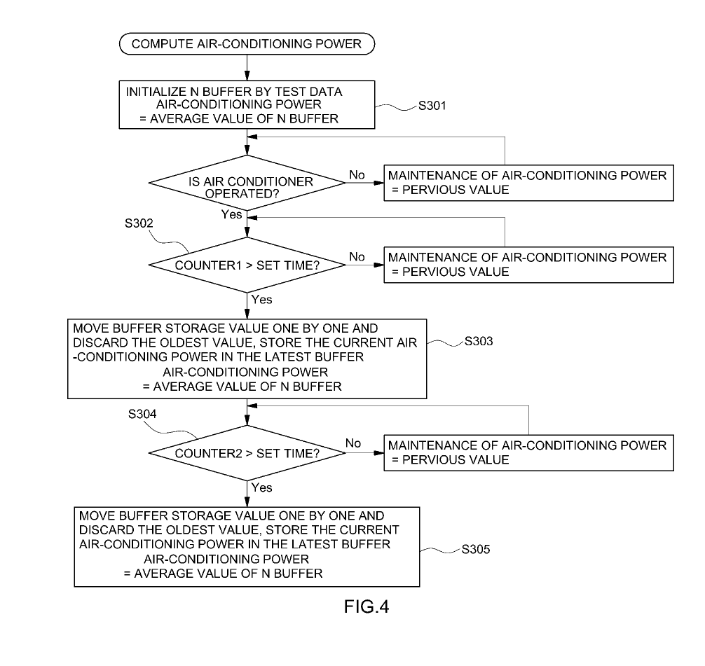

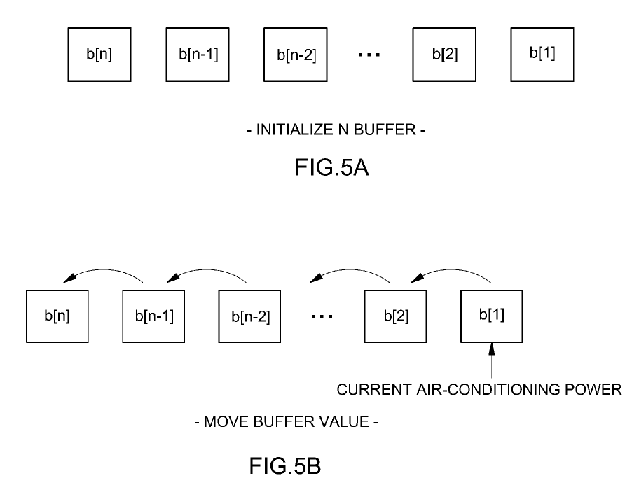

Accompanying FIG. 4 is a flowchart illustrating the calculation of the air-conditioning power, and FIG. 5A and 5B are conceptual diagrams thereof. The air-conditioning power may be affected by four factors of a solar radiation, an indoor temperature, an outdoor temperature, and a set temperature. Particularly, the air-conditioning power behavior test based on the above four factors may be performed until the full-discharge after the full-charge of the battery of the eco-friendly vehicle, and the test data are stored in the N buffers.

During operation of the vehicle controller, when the N buffers as the temporary storage device included in the controller are initialized, the N buffers may be initialized to the above-mentioned test data, and the air-conditioning power may become the average value of each test data stored in the N buffers (S301). Thereafter, when the air conditioner is operated, the controller (e.g., the vehicle controller) may be configured to determine whether the operating time of the air conditioner (e.g., the first counter time) is a set time (e.g., air-conditioning stabilization time) (S302). When the operation is performed for the set time or greater, the air-conditioning power data update (e.g., an upgrade) may be performed.

In other words, when the first operation count time of the air conditioner is the set time (e.g., air-conditioning stabilization time) or greater, the actual power consumed by the air conditioner from this time may be stored in the buffer, and the air-conditioning power data stored in the earliest buffer may be deleted (S303). Particularly, as illustrated in accompanying FIG. 5A and 5B, after the N buffers are initialized, the air conditioner may be operated and the actual power consumed by the air conditioner may be stored in the latest buffer (e.g., replacing the earliest data), the air-conditioning power data may be moved and stored for each previous buffer one by one, at the same time, the earliest (e.g., oldest) buffer storage value may be removed, and the final air-conditioning power may become the average value of the air-conditioning power stored in the N buffers. In other words, each previous data set may be updated based on the new data set.

When the air conditioner continues to operate, the controller may be configured to determine whether the second operation counter time is the set time (e.g., conditioning stabilization time) or greater (S304), when operated for the set time or greater, the same air-conditioning power data updating as in the above process S303 may be repeated (S305), and at this time, similarly, the final air-conditioning power may become an average value of the air-conditioning power stored in the N buffers. Accordingly, when traveling fuel consumption, average vehicle speed and air-conditioning power computed in the vehicle controller is substituted for the above-mentioned equation 2, it may be possible to more accurately calculate the reduce fuel consumption (km/kWh) during operation of the air conditioner.

Finally, by substituting the reduced fuel consumption (km/kWh) during operation of the air conditioner for the above-mentioned equation 1, that is, “distance to empty (km)=(learning traveling fuel consumption (km/kWh)×reduced fuel consumption during operation of air conditioner (km/kWh))×battery available energy (kWh)”, it may be possible to more accurately calculate the distance to empty in consideration of the operation of the air conditioner.

The invention has been described in detail with reference to exemplary embodiments thereof. However, it will be appreciated by those skilled in the art that changes may be made in these exemplary embodiments without departing from the principles and spirit of the invention, the scope of which is defined in the appended claims and their equivalents.

What is claimed is:

1. A calculation method of a distance to empty method of an eco-friendly vehicle, comprising:
calculating, by a controller, a reduced fuel consumption during operation of an air conditioner, using a traveling fuel consumption obtained by calculating a traveling fuel consumption, an average vehicle speed obtained by calculating an average vehicle speed, and an air-conditioning power obtained by calculating an air-conditioning power; and
calculating, by the controller, a distance to empty using the calculated the reduced fuel consumption during operation of the air conditioner.

2. The method of claim 1, wherein the traveling fuel consumption calculation includes:
storing, by the controller, the fuel consumption of a past traveling cycle;
storing, by the controller, save the fuel consumption of a current traveling cycle; and
calculating, by the controller, an average value between the fuel consumption of the past of N traveling cycles and the fuel consumption of the current traveling cycle as the traveling fuel consumption.

3. The method of claim 2, wherein when the traveling route is determined by a navigation system, the traveling fuel consumption calculation further includes:
computing, by the controller, the fuel consumption based on a distance for each road type, an average fuel consumption for each road, and a weighted average according to the distance to empty; and
computing, by the controller, an average value between the computed fuel consumption average value and the computed fuel consumption based on road information.

4. The method of claim 1, wherein the average vehicle speed calculation includes:
storing, by the controller, the average vehicle speed of the past of the N traveling cycles;
storing, by the controller, the average vehicle speed from a start to a present of a current traveling cycle; and
calculating, by the controller, an average value between the average vehicle speed of the past traveling cycle stored in the N buffer and the average vehicle speed of the current traveling cycle as the average vehicle speed.

5. The method of claim 4, wherein when the traveling route is determined by a navigation system, the average vehicle speed calculation further includes:
receiving, by the controller, a distance for each road type and an average speed of each road type to compute an average vehicle speed; and
computing, by the controller, the average value between the obtained average vehicle speed and the computed average vehicle speed as the average vehicle speed;

6. The method of claim 1, wherein the air-conditioning power calculation includes:
initializing, by the controller, the N buffer as a temporary storage device by storing the air-conditioning power test data during operation of the vehicle controller; and
updating, by the controller, the air-conditioning power data of the N buffers and simultaneously calculating the air-conditioning power, when the air conditioner is operated for a first operation counter time or greater.

7. The method of claim 6, wherein in the process of updating the air-conditioning power data and simultaneously calculating the air-conditioning power, the actual power consumed by the air conditioner is stored in the latest buffer, at the same time, the air-conditioning power data stored in the earliest buffer is deleted, and the final air-conditioning power is calculated as the average value of the air-conditioning power stored in the N buffer.

8. The method of claim 7, wherein the air-conditioning power calculation further includes:
when the air conditioner operates at the second operation counter time or greater, repeating, by the controller, the air-conditioning power data update and recalculating the air-conditioning power.

9. The method of claim 1, wherein the reduced fuel consumption during operation of the air conditioner is calculated by:
reduced fuel consumption during operation of air conditioner (km/kWh)=traveling fuel consumption (km/kWh)−[average vehicle speed (km/h)/[[average vehicle speed (km/h)/traveling fuel consumption (km/kWh)]+air-conditioning power (kW)]

10. The method of claim 1, wherein the distance to empty is calculated by:
distance to empty (km)=(learning traveling fuel consumption (km/kWh)×reduced fuel consumption during operation of air conditioner (km/kWh))×battery available energy (kWh)

11. A calculation system of a distance to empty method of an eco-friendly vehicle, comprising:
a memory configured to store program instructions; and
a processor configured to execute the program instructions, the program instructions when executed configured to:
calculate a reduced fuel consumption during operation of an air conditioner, using a traveling fuel consumption obtained by calculating a traveling fuel consumption, an average vehicle speed obtained by calculating an average vehicle speed, and an air-conditioning power obtained by calculating an air-conditioning power; and
calculate a distance to empty using the calculated the reduced fuel consumption during operation of the air conditioner.

12. The system of claim 11, wherein the program instructions when executed for the traveling fuel consumption calculation are further configured to:
store the fuel consumption of a past traveling cycle;
store save the fuel consumption of a current traveling cycle; and
calculate an average value between the fuel consumption of the past of N traveling cycles and the fuel consumption of the current traveling cycle as the traveling fuel consumption.

13. The system of claim 11, wherein the program instructions when executed for the average vehicle speed calculation are further configured to:
store the average vehicle speed of the past of the N traveling cycles;
store the average vehicle speed from a start to a present of a current traveling cycle; and
calculate an average value between the average vehicle speed of the past traveling cycle stored in the N buffer and the average vehicle speed of the current traveling cycle as the average vehicle speed.

14. The system of claim 11, wherein the program instructions when executed for the air-conditioning power calculation are further configured to:
initialize the N buffer as a temporary storage device by storing the air-conditioning power test data during operation of the vehicle controller; and
update the air-conditioning power data of the N buffers and simultaneously calculating the air-conditioning power, when the air conditioner is operated for a first operation counter time or greater.

15. A non-transitory computer readable medium containing program instructions executed by a controller, the computer readable medium comprising:
program instructions that calculate a reduced fuel consumption during operation of an air conditioner, using a traveling fuel consumption obtained by calculating a traveling fuel consumption, an average vehicle speed obtained by calculating an average vehicle speed, and an air-conditioning power obtained by calculating an air-conditioning power; and
program instructions that calculate a distance to empty using the calculated the reduced fuel consumption during operation of the air conditioner.

16. The non-transitory computer readable medium of claim 15, further comprising for the traveling fuel consumption calculation:
program instructions that store the fuel consumption of a past traveling cycle;
program instructions that store save the fuel consumption of a current traveling cycle; and
program instructions that calculate an average value between the fuel consumption of the past of N traveling cycles and the fuel consumption of the current traveling cycle as the traveling fuel consumption.

17. The non-transitory computer readable medium of claim 15, further comprising for the average vehicle speed calculation:
program instructions that store the average vehicle speed of the past of the N traveling cycles;
program instructions that store the average vehicle speed from a start to a present of a current traveling cycle; and
program instructions that calculate an average value between the average vehicle speed of the past traveling cycle stored in the N buffer and the average vehicle speed of the current traveling cycle as the average vehicle speed.

18. The non-transitory computer readable medium of claim 15, further comprising for the air-conditioning power calculation:
program instructions that initialize the N buffer as a temporary storage device by storing the air-conditioning power test data during operation of the vehicle controller; and
program instructions that update the air-conditioning power data of the N buffers and simultaneously calculating the air-conditioning power, when the air conditioner is operated for a first operation counter time or greater.
